(19) United States
(12) Patent Application Publication
(10) Pub. No.: US 2010/0312716 A1
(43) Pub. Date: Dec. 9, 2010

(54) System and Method for Conditional Modification of Buy and Sell Orders in Electronic Trading Exchange

(76) Inventors: Richard Lane, Chicago, IL (US); Michael Unetich, Chicago, IL (US)

Correspondence Address: MBHB/TRADING TECHNOLOGIES, 300 SOUTH WACKER DRIVE, SUITE 3200, CHICAGO, IL, 60606, US

(21) Appl. No.: 12/479,907

(22) Filed: Jun. 8, 2009

(51) Int. Cl. G06Q 40/00; G06F 15/16

(52) U.S. Cl. 705/36 R; 705/37; 709/206

(57) ABSTRACT

A system and method for automatically modifying buy and sell orders in an electronic trading exchange is described. The trader system includes a user device for submitting trader buy and sell orders and conditional quantities, and a trading application which receives the trader buy and sell orders and conditional quantities and communicates these to a host exchange system. For each conditional quantity associated with a trader buy order, the trading application monitors an inside ask quantity associated with the identified desired tradable object of that trader buy order such that if the associated inside ask quantity becomes less than the conditional quantity, then the trading application modifies the trader buy order to increase the desired buy price by a predetermined user-defined increment or to the inside ask price associated with the identified desired tradable object and communicates the modified buy order to the host exchange system. Similar operation occurs for a trader sell order, with the desired inside sell price being decreased if an associated inside bid quantity becomes less than the corresponding conditional quantity.

### FIELD OF THE INVENTION

The present invention relates to an electronic trading exchange, and more particularly, to a system and method for automatically modifying buy and sell orders based on existing trading conditions.

### BACKGROUND OF THE INVENTION

Trading exchanges have advanced from in-person floor trading operations to technology-enabled electronic trading exchanges that allow remote users to participate in various markets. In general, sellers submit sell orders (offers or asks) with prices at which they will sell a specified quantity of tradable objects, and buyers submit buy orders (bids) with prices at which they will buy a specified quantity of tradable objects. A tradable object, as used herein, refers to any object which can be traded with a price and a quantity, and includes various items such as stocks, bonds, funds, futures, spreads, options, commodities, etc. In an electronic trading exchange, a host exchange system disseminates to all connected participants market data relating to bids, offers, and trades in order to provide the same transparency that floor traders are provided. Sellers try to sell at the highest price and buyers try to buy at the lowest price, and an exchange matching system facilitates the matching of bids and offers in order to execute trades.

Most host exchange systems provide notifications corresponding to all submitted buy and sell orders and executed trades as they occur and so it is up to a trader's computer system and a trading application to maintain a current book for each tradable object, which is a consolidation of all information related to prices and quantities for that tradable object at a particular point in time. Especially important from a trader's point of view is inside market information, including the current highest bid price and lowest ask price. A bid price corresponds to what a trader is willing to currently pay for a tradable object, and an ask price corresponds to what a trader is willing to currently accept for a tradable object. In futures markets, the separation between the highest bid price and lowest ask price is often a referred to as a tick, which is a smallest allowable increment of price movement for the corresponding contract. Typically in futures markets, a tick value is generally in the range of $6 to $25.

If a trader wants to buy a tradable object and it is important to that trader that an executed trade occurs, the trader can simply submit an initial buy order (or market order) to buy at the lowest ask price. Although this is a low risk approach that generally achieves a trade execution, it is less satisfactory from a maximum profitability standpoint because of the higher price involved.

With a second approach, the trader can initially submit a buy order (limit order) at the current highest bid price, thereby “joining the bid”, and then monitor the trading activity. The desired tradable object may trade next at the bid price or at the ask price. If the tradable object begins to trade at the ask price, the trader can then decide to manually change the order price to that ask price, hopefully before the entire ask quantity is gone (trades out). With this approach, there is a risk that the trader will be left without the desired execution, especially if the ask quantity quickly trades out. For example, if the entire quantity offered for sale at the ask price is already bought before the order price is manually changed and submitted to the host exchange system, then the new buy order will become the new highest bid price or will be joining the bid at that level. The trader will continue to undertake the risk that the buy order may remain unexecuted if the market continues to trade at higher prices.

Traders thus are often required to quickly evaluate the tradeoffs between a less favorable price on a desired trade and the risk that a desired trade will remain unexecuted.

### BRIEF SUMMARY OF THE INVENTION

Therefore, it would be advantageous for a trader system and method to increase the likelihood that a desired trade be executed while attempting to achieve the most favorable price. It would be advantageous for a trader system and method to automatically modify a conditional buy or sell order, wherein an available bid or ask quantity at a corresponding inside bid or ask price is the condition triggering the modification of a buy or sell order to a respective higher or lower price.

In at least some embodiments, the present invention relates to a method for automatically modifying buy and sell orders in an electronic trading exchange. The method includes receiving market data from a host exchange system and updating a current book for each of a plurality of tradable objects using the market data. Each current book includes an inside bid price, an inside bid quantity, an inside ask price, and an inside ask quantity. The method further includes receiving trader buy and sell orders and optional conditional quantities, wherein each trader buy or sell order identifies a desired tradable object, a desired buy or sell price, and an desired quantity to buy or sell, and each conditional quantity is associated with a respective one of the trader buy and sell orders, and communicating the trader buy and sell orders to a host exchange system. The method includes modifying each communicated trader buy order which has an associated conditional quantity to increase the desired buy price by a pre-determined user defined increment, or to the inside ask price associated with the identified desired tradable object of the trader buy order if the associated inside ask quantity becomes less than the conditional quantity, modifying each communicated trader sell order which has an associated conditional quantity to decrease the desired sell price by a pre-determined user defined increment, or to the inside bid price associated with the identified desired tradable object of the trader sell order if the associated inside bid quantity becomes less than the conditional quantity, and communicating the modified buy and sell orders to the host exchange system.

In other embodiments, the invention relates to a trader system for automatically modifying buy and sell orders in an electronic trading exchange, the trader system including a user device for submitting trader buy and sell orders and conditional quantities, wherein each trader buy or sell order identifies a desired tradable object and includes a desired buy or sell price and a desired quantity to buy or sell; and each conditional quantity is associated with a respective one of the trader buy and sell orders. The trader system also includes a processor in electronic communication with the user device and with a host exchange system and running a trading application which receives the trader buy and sell orders and conditional quantities and communicates the trader buy and sell orders to the host exchange system. The trading application also receives market data and maintains, for each of the desired tradable objects, a current book of inside market information including an associated inside bid price, an associated inside bid quantity, an associated inside ask price, and an associated inside ask quantity. For each conditional quantity associated with a trader buy order, the trading application monitors the inside ask quantity associated with the identified desired tradable object of that trader buy order such that if the associated inside ask quantity becomes less than the conditional quantity, then the trading application modifies the trader buy order to increase the desired buy price to the inside ask price associated with the identified desired tradable object, or increases the desired buy price by a predetermined user-defined amount, and communicates the modified buy order to the host exchange system. Further, for each conditional quantity associated with a trader sell order, the trading application monitors the inside bid quantity associated with the identified desired tradable object of that trader sell order such that if the associated inside bid quantity becomes less than the conditional quantity, then the trading application modifies the trader sell order to decrease the desired sell price to the inside bid price associated with the identified desired tradable object, or decreases the desired sell price by a predetermined user-defined amount, and communicates the modified sell order to the host exchange system.

### BRIEF DESCRIPTION OF THE DRAWINGS

FIG. 1 is a block diagram of an exemplary electronic trading exchange in accordance with at least one aspect of the invention;

FIG. 2 is an illustration of a display screen showing an order ticket for a tradable object;

FIG. 3 is an illustration of a display screen showing a listing of working orders; and

FIG. 4 is a flow chart of an exemplary method for automatically modifying trader buy or sell orders in accordance with at least one aspect of the invention.

### DETAILED DESCRIPTION OF THE PREFERRED EMBODIMENT

The present invention is described herein with reference to one or more exemplary embodiments, however, it should be understood that the present invention is not limited to these embodiments. Those skilled in the art will appreciate that other arrangements and other elements can be used instead, and some elements may be omitted altogether. Further, as in most electronic systems, those skilled in the art will appreciate that various components can be implemented as discrete or distributed components, and various functions can be implemented by software, hardware, and/or firmware. For example, a processor executing a set of machine language instructions stored in memory (software) may perform various functions. Provided with the present disclosure describing several functions, those skilled in the art can readily prepare appropriate computer instructions to enable such functions.

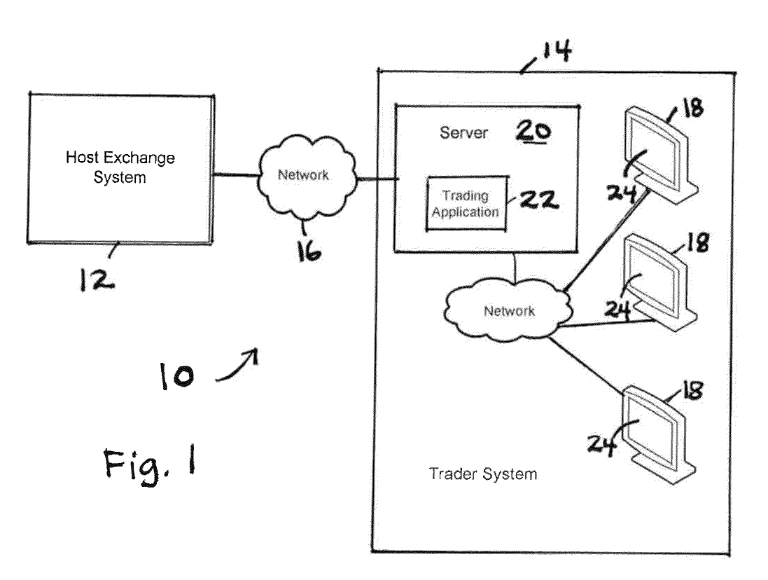

Referring to FIG. 1, a block diagram of an exemplary electronic trading exchange 10 is illustrated which includes a host exchange system 12 in communication with one or more trader systems 14 via one or more networks 16. This electronic trading exchange 10 allows traders to electronically participate in the market using user devices 18 to receive and evaluate market information and enter buy and sell orders for any of a variety of tradable objects supported by that exchange system.

The host exchange system 12 includes various computers, servers, and applications, and is supported by any of a variety of exchange organizations, such as the New York Stock Exchange, the Chicago Mercantile Exchange, or the like. As is known, the host exchange system performs several functions including the receipt and review of the submitted buy and sell orders from various trader systems, and the prioritization and matching of these orders to generate executed trades. Further, the host exchange system continually provides market data to the trader systems, including information corresponding to all the submitted buy and sell orders for each of the tradable objects traded on the exchange, and executed trade information which includes, for each executed trade, an identification of the associated tradable object traded, the trade price, the trade quantity, and the execution time. Different exchanges can provide this information in various formats and ways, such as reporting every order or trade as it occurs, or reporting at pre-specified time intervals.

The network 16 provides electronic communication between the host exchange system 12 and the trader system 14 and can take any of a variety of forms, including the Internet, wired or wireless connections, secured or unsecured communication, as is known.

Similarly, the trader system 14 can be implemented in a variety of ways, with the illustrated embodiment including a server 20 or processor that is capable of running a software trading application 22 that, among other features, facilitates the display of various items, such as order tickets and working order listings, on the display screen 24 of one or more of the user devices 18. The trading application receives submitted trader buy and sell orders along with conditional quantities from the user devices 18, and communicates the buy and sell orders to the host exchange system 12. The trading application 22 monitors market conditions and modifies a trader buy or sell order as described below to change a desired bid price or a desired ask price under certain conditions, and communicates any modified buy or sell orders to the host exchange system 12.

Most exchange systems, including host exchange system 12, provide market data in the form of notifications corresponding to all executed trades and submitted buy and sell orders (including modifications and/or cancellations) as the underlying events occur. The trading application 22 receives this market data and operates to maintain and update, for each desired tradable object of interest, a current book of inside market information, which is a consolidation of all the information related to prices and quantities for that tradable object, and includes an associated inside bid price, an associated inside bid quantity, an associated inside ask price, and an associated inside ask quantity. This information changes as market conditions change and trades are executed.

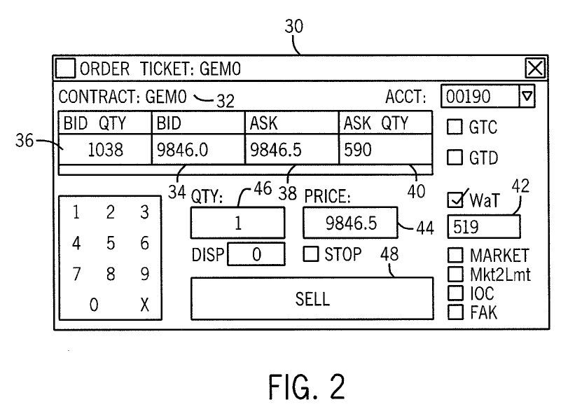

The user devices 18 can take various forms such as personal computers or hand-held devices and can be connected to the server via a network 26, such as a local or wide area network, in a wired or wireless manner. The user devices 18 each include a user interface with a display screen 24 and means for entering trader buy and sell orders, such as a keyboard, a mouse, a touch-screen interface, or the like. Conditional quantities can also be entered via the user device 18, with each conditional quantity associated with a respective one of the trader buy or sell limit orders. In this regard, the trading application 22 facilitates the display of an order ticket 30, such as that shown in FIG. 2, on the display screen 24 of a user device 18. This order ticket 30 can be opened as a window on the display screen 24 and allows a user to enter buy or sell order information. The order ticket 30 displays an identification of the corresponding tradable object in field 32, and current inside market information associated with that tradable object, including a current inside bid price in box 34, a current inside bid quantity in box 36, a current inside ask price in box 38, and a current inside ask quantity in box 40. As mentioned, the inside market information is continually updated by the trading application 22 as market conditions change and provides useful information to a trader for setting a conditional quantity if desired.

The order ticket 30 allows a trader to specify an associated desired buy or sell price in box 44, an associated desired quantity to buy or sell in box 46, and an optional associated conditional quantity in box 42. The use of a conditional quantity increases the likelihood that a trader buy or sell order will be executed, although perhaps at a different desired price than initially specified. Once a trader's selections are entered, the sell order can be submitted, such as by clicking on a sell button 48. Once submitted, the trading application 22 receives the buy or sell order and any associated conditional quantity and communicates the buy or sell order to the host exchange system.

If a trader does not enter a value in box 42, a default conditional quantity can be implemented, such as a predetermined fraction (e.g. ½) of the quantity corresponding to the opposite side of the corresponding buy or sell order. Another possibility for when a trader does not enter a value in box 42 is for the trading application to simply communicate a corresponding submitted buy or sell order to the host exchange system 12, but not undertake to automatically modify it later.

Assuming an active entered or default conditional quantity is utilized, the trading application then monitors an associated inside bid or inside ask quantity which corresponds to the inside price on the other side of a desired transaction. In particular, for each conditional quantity associated with a trader buy order submitted at an inside bid price, the trading application monitors the inside ask quantity associated with the identified desired tradable object of that trader buy order. If the inside ask quantity subsequently becomes less than (or less than or equal to) the conditional quantity, then the trading application modifies the trader buy order to increase the desired buy price to the inside ask price associated with the identified desired tradable object, and communicates the modified buy order to the host exchange system. In another embodiment, if the inside ask quantity becomes less than (or less than or equal to) the conditional quantity, then the trading application modifies the trader buy order to increase the desired buy price by a predetermined user-defined quantity, such as a tick increment or another quantity that can be less than the inside spread. In this case, the user-defined quantity can be input on the order ticket.

Similarly, for each conditional quantity associated with a trader sell order submitted at an inside ask price, the trading application monitors the inside bid quantity associated with the identified desired tradable object of that trader sell order. If the inside bid quantity subsequently becomes less than (or less than or equal to) the conditional quantity, then the trading application modifies the trader sell order to decrease the desired sell price to the inside bid price associated with the identified desired tradable object, and communicates the modified sell order to the host exchange system. In another embodiment, if the inside bid quantity becomes less than (or less than or equal to) the conditional quantity, then the trading application modifies the trader sell order to decrease the desired sell price by a predetermined user-defined quantity.

For example, in the illustrated order ticket 30 of FIG. 2, a trader is attempting to sell one contract of a tradable object identified by GEM0 at a desired ask price of 9846.5, with a selected conditional quantity of 519. The current inside market information corresponding to GEM0 is an inside bid price of 9846.0 with an associated inside bid quantity of 1038, and an inside ask price of 9846.5 with an associated inside ask quantity of 590. In this example, the conditional quantity of 519 contracts is selected by the trader and entered in box 42 to temper the risk that the trader's sell order will not be executed. The selection of the conditional quantity can be made based on a rough supply and demand analysis, where it can be assumed that subsequent trades are likely to occur on the bid or the ask side having the lesser quantity. Using this rough analysis in this example, subsequent trades are likely to occur at the inside ask price since the available quantity is less than the available quantity at the inside bid price. Here 519 is selected as the conditional quantity merely because it is one-half of the current inside bid quantity of 1038 contracts. The trader can select a specific value for the conditional quantity depending on how much risk the trader wants to undertake that the buy or sell order will not be executed.

The trading application 22 then monitors the inside bid quantity, and in the event that the inside bid quantity drops below the conditional quantity of 519, then the trading application operates to modify the submitted sell order to change the desired sell price from 9846.5 to 9846.0. In futures trading parlance this is referred to as “taking a tick” and futures traders especially are very often and sometimes exclusively trying to make the minimum tick increment in their market all day every day. Corresponding ticks are generally in the range of $6.25 to $25 per contract, so to obtain better and more efficient execution on 100 contracts a couple of times a day is quite advantageous.

As another example, assume a market for a tradable object with a current book having an inside bid price of 95.260, an associated inside bid quantity of 1000 contracts, an inside ask price of 95.265, and an associated inside ask quantity of 2000 contracts. A rough supply and demand analysis indicates that the 95.260 price will trade next. A trader looking to buy a quantity of 100 contracts may select a conditional quantity of 1000 contracts as a medium risk point, because if the corresponding inside ask quantity subsequently changes to 1000 contacts, that means that 1000 contracts would have been bought already. On the other hand, a selected conditional quantity of 500 contracts would be considered a higher risk, because that indicates that 1500 contracts would have been bought already in a larger trade. A conditional quantity of 500 contracts would be considered a lower risk. In this example, a trader may want to select the less risky conditional quantity of 1500 just in case the inside bid quantity increases in size to 5000 for example, and then the odds shift in favor of the inside ask price trading next.

As another example, with respect to shares of Google stock (GOOG), assume that an existing inside bid price is $325 with an associated inside bid quantity of 5000 and an existing inside ask price of $325.01 with an associated inside ask quantity of 1,000,000. A simplified supply and demand analysis indicates that the lower price is much more likely to trade next, because the available quantity at the inside bid price is much less than the available quantity at the inside ask price. In this case, most traders hoping to buy would just enter a limit order at the bid price, rather than spending more money to buy at the inside ask price. However, a market is not always going to trade next at the likely price determined by a simplified supply and demand analysis, and the use of a conditional quantity aids the trader by quickly and automatically adapting to changing market conditions.

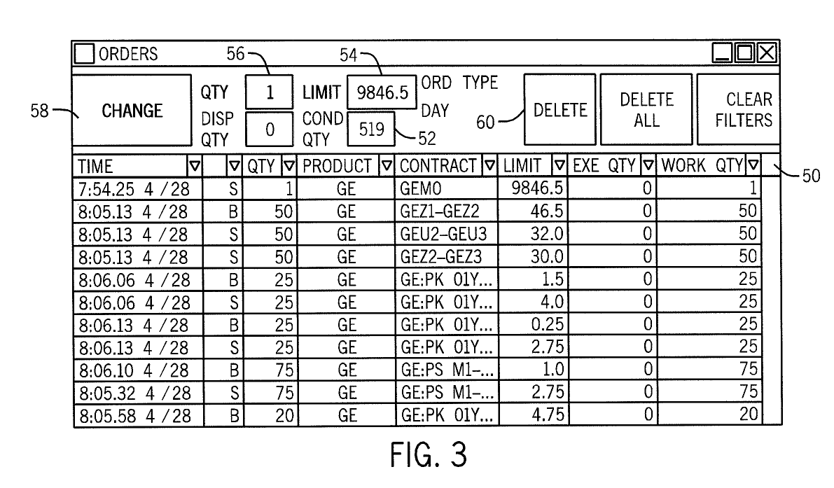

In addition to the trading application 22 modifying a trader buy or sell order according to changing market conditions, a trader can also manually modify a buy or sell order and/or modify the selected conditional quantity associated with a trader buy or sell order. In this regard, the trading application 22 also facilitates the display of an order book 50, which is a listing of the open, currently working orders, such as shown in FIG. 3. By selecting and highlighting one of the listed working orders, its corresponding parameters are displayed. Then a trader can manually modify a corresponding desired quantity in box 56, a corresponding desired price in box 54, and/or the conditional quantity in box 52. The modified order can then be submitted by clicking on the change button 58. Further, the delete box 60 allows a trader to delete the order by clicking on box 60.

Referring to the example depicted in FIG. 2, assume some time has passed and market conditions have changed such that the current inside market information corresponding to the GEM0 tradable object has changed to an inside bid price of 9846.0 with an inside bid quantity of 752, and an inside ask price of 9846.5 with an inside ask quantity of 3280. A supply-demand analysis now indicates that the bid side rather than the ask side is likely to be the first side to trade because the bid quantity now is less than the ask quantity. In order to temper the risk that one or more of the traders with sell orders will change their price to the inside bid price, a new conditional quantity, such as 700, can be entered in box 52, and the change button 58 clicked on to submit this to the trading application 22. In this case, if fifty three (53) or more contracts leave the bid side, either by buyers cancelling their order or by trades occurring at the inside bid price, then the submitted trader sell order at 9846.5 will be modified to change the sell price to 9846.0. Alternatively, a trader can simply change the desired price box 54 (limit field) to 9846.0 and click on the change button and this will immediately submit the modified order at the modified price.

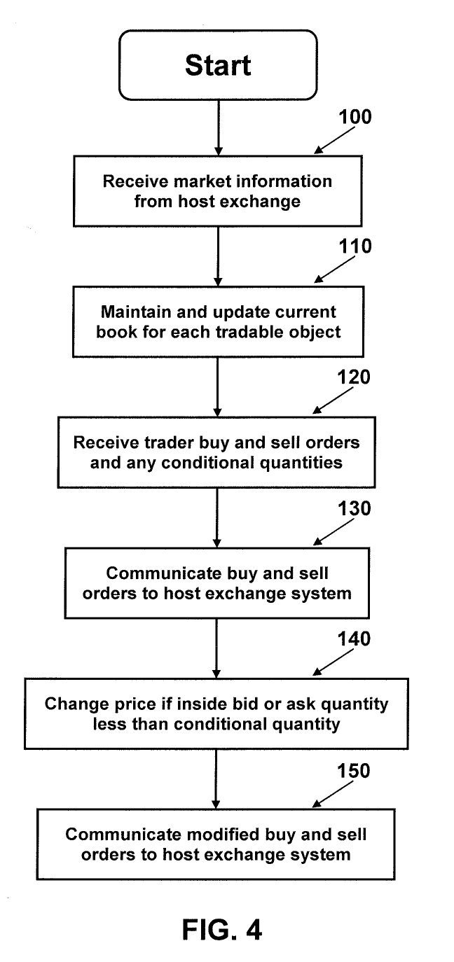

Referring now to FIG. 4, a method is illustrated showing the steps performed by the trading application 22 of the trader system for automatically modifying buy and sell orders in an electronic trading exchange. At a step 100, the trading application continually receives market data from a host exchange system. At a step 110, the trading application maintains and updates a current book for each of a plurality of relevant tradable objects using the market data. This is also on-going. At any point in time, the current book includes an inside bid price, an inside bid quantity, an inside ask price, and an inside ask quantity for the associated tradable object.

At a step 120, the trading application receives trader buy and sell orders and optional conditional quantities from a user device. Each trader buy or sell order identifies a desired tradable object, and includes a desired buy or sell price and an desired quantity to buy or sell. Each conditional quantity is associated with a respective one of the trader buy and sell orders.

At a step 130, the trader buy and sell orders are communicated to a host exchange system in a known manner.

At a step 140, each communicated trader buy order which has an associated conditional quantity is modified to increase the desired buy price by a predetermined user-defined increment (such as a tick) or to the inside ask price associated with the identified desired tradable object of the trader buy order if the associated inside ask quantity becomes less than the conditional quantity, and each communicated trader sell order which has an associated conditional quantity is modified to decrease the desired sell price by a predetermined user-defined increment or to the inside bid price associated with the identified desired tradable object of the trader sell order if the associated inside bid quantity becomes less than the conditional quantity.

At a step 150, the modified buy and sell orders are communicated to the host, exchange system.

Thus, this trader system enables a trader to operate in a more efficient, advantageous, and convenient manner. For a market-maker, these advantages translate into more liquid and deeper markets, one of the great and envied attributes of this country's capital markets.

It is specifically intended that the present invention not be limited to the embodiments and illustrations contained herein, but include modified forms of those embodiments including portions of the embodiments and combinations of elements of different embodiments as come within the scope of the following claims.

We claim:

1. A trader system for automatically modifying buy and sell orders in an electronic trading exchange, the trader system comprising:
a user device for submitting trader buy and sell orders and conditional quantities, wherein each trader buy or sell order identifies a desired tradable object and includes a desired buy or sell price and a desired quantity to buy or sell; and each conditional quantity is associated with a respective one of the trader buy and sell orders; and
a processor in electronic communication with the user device and with a host exchange system and running a trading application which receives the trader buy and sell orders and conditional quantities and communicates the trader buy and sell orders to the host exchange system, wherein the trading application also receives market data and maintains, for each of the desired tradable objects, a current book of inside market information including an associated inside bid price, an associated inside hid quantity, an associated inside ask price, and an associated inside ask quantity;
wherein for each conditional quantity associated with a trader buy order, the trading application monitors the inside ask quantity associated with the identified desired tradable object of that trader buy order such that if the associated inside ask quantity becomes less than the conditional quantity, then the trading application modifies the trader buy order to increase the desired buy price to the inside ask price associated with the identified desired tradable object and communicates the modified buy order to the host exchange system; and
wherein for each conditional quantity associated with a trader sell order, the trading application monitors the inside bid quantity associated with the identified desired tradable object of that trader sell order such that if the associated inside bid quantity becomes less than the conditional quantity, then the trading application modifies the trader sell order to decrease the desired sell price to the inside bid price associated with the identified desired tradable object and communicates the modified sell order to the host exchange system.

2. The trader system of claim 1, wherein the trading application receives the market information from the host exchange system.

3. The trader system of claim 1, wherein the trading application causes an order ticket for a selected tradable object to be displayed on the user device.

4. The trader system of claim 3, wherein the displayed order ticket includes the associated inside bid price and the associated inside bid quantity.

5. The trader system of claim 3, wherein the displayed order ticket includes the, associated inside ask price and the associated inside ask quantity.

6. The trader system of claim 1, wherein the trading application causes the communicated buy and sell orders to be displayed on the user device, wherein each displayed buy or sell order is selectable in order to allow a manual modification of the desired price or the desired quantity.

7. The trader system of claim 6, wherein any manual modifications are communicated to the host exchange system.

8. The trader system of claim 1, wherein the trading application causes the communicated buy and sell orders to be displayed on the user device, wherein each displayed buy or sell order is selectable in order to allow a manual modification of the associated conditional quantity.

9. The trader system of claim 8, wherein any manual modifications arc communicated to the host exchange system.

10. A method for automatically modifying buy and sell orders in an electronic trading exchange, the method comprising:
receiving market data from a host exchange system,
updating a current book for each of a plurality of tradable objects using the market data, the current book including an inside bid price, an inside bid quantity, an inside ask price, and an inside ask quantity;
receiving trader buy and sell orders and optional conditional quantities, wherein each trader buy or sell order identifies a desired tradable object, a desired buy or sell price, and an desired quantity to buy or sell, and each conditional quantity is associated with a respective one of the trader buy and sell orders;
communicating the trader buy and sell orders to a host exchange system;
modifying each communicated trader buy order which has an associated conditional quantity to increase the desired buy price to the inside ask price associated with the identified desired tradable object of the trader buy order if the associated inside ask quantity becomes less than the conditional quantity,
modifying each communicated trader sell order which has an associated conditional quantity to decrease the desired sell price to the inside bid price associated with the identified desired tradable object of the trader sell order if the associated inside bid quantity becomes less than the conditional quantity, and
communicating the modified buy and sell orders to the host exchange system.

11. The method of claim 10, further including displaying on a user device an order ticket for a selected tradable object, the order ticket including the inside bid price and the inside bid quantity.

12. The method of claim 10, further including displaying on a user device an order ticket for a selected tradable object, the order ticket including the inside ask price and the inside ask quantity.

13. The method of claim 10, further including displaying on a user device a listing of communicated buy and sell orders.

14. The method of claim 13, further including receiving manual modifications to the associated desired price, the associated desired quantity, or the associated conditional quantity of selected communicated buy and sell orders.

15. The method of claim 14, further including communicating any manual modifications to the host exchange system.

16. A method for automatically modifying buy and sell orders in an electronic trading exchange, the method comprising:
receiving market data from a host exchange system,
updating a current book for each of a plurality of tradable objects using die market data, the current book including an inside bid quantity and an inside ask quantity;
receiving trader buy and sell orders and optional conditional quantities, wherein each trader buy or sell order identifies a desired tradable object, a desired buy or sell price, and an desired quantity to buy or sell, and each conditional quantity is associated with a respective one of the trader buy and sell orders;
communicating the trader buy and sell orders to a host exchange system;
modifying each communicated trader buy order which has an associated conditional quantity to increase the desired buy price by a pre-determined user defined increment if the associated inside ask quantity becomes less than the conditional quantity,
modifying each communicated trader sell order which has an associated conditional quantity to decrease the desired buy price by a pre-determined user defined increment if the associated inside bid quantity becomes less than the conditional quantity, and
communicating the modified buy and sell orders to the host exchange system.

17. The method of claim 16, further including displaying on a user device an order ticket for a selected tradable object, the order ticket including the inside bid price and the inside bid quantity.

18. The method of claim 16, further including displaying on a user device an order ticket for a selected tradable object, the order ticket including the inside ask price and the inside ask quantity.

19. The method of claim 16, further including receiving manual modifications to the associated desired price, the associated desired quantity, or the associated conditional quantity of selected communicated buy and sell orders.

20. The method of claim 19, further including communicating any manual modifications to the host exchange system.
